(19) United States
(12) Patent Application Publication
(10) Pub. No.: US 2009/0020576 A1
(43) Pub. Date: Jan. 22, 2009

(54) FOLDABLE CHAIR

(76) Inventor: Paul Alexander Gale, Hawkes Bay (NZ)

Correspondence Address: YOUNG & THOMPSON, 209 Madison Street, Suite 500, ALEXANDRIA, VA, 22314, US

(21) Appl. No.: 11/793,780

(22) PCT Filed: Oct. 12, 2005
(86) PCT No.: PCT/NZ05/00261

§ 371 Date: Jun. 21, 2007

(30) Foreign Application Priority Data
Oct. 12, 2004 (NZ) 535879
Mar. 2, 2005 (NZ) 538558

(51) Int. Cl. B60R 9/00

(52) U.S. Cl. 224/498

(57) ABSTRACT

A foldable carrier (10) including a mounting frame (11), a floor (14) movably coupled to the mounting frame (11), side frames (12) movably coupled to the mounting frame (11) and connecting means (20, 21) for connecting the side frames (12) to the floor (14) for retaining the floor (14) in an in-use position, the floor (14) and side frames being moveable to a compacted state and held therein by retention means.

### BACKGROUND OF THE INVENTION

This invention relates to a foldable carrier.

The foldable carrier according to the present invention is of a type that can be a structural part, fitting, or an accessory on all vehicles by land, air and water. It can also be adapted as a system for racking, stacking, and shelving units in warehousing, expos, exhibitions, trade shows, retailing, indoor/outdoor markets and other similar activities.

The all terrain vehicle (commonly referred to as an ATV) has become a widely used utility vehicle especially in the farming sector. Not only is the ATV commonly used for transportation of a farm worker but it is also used for carrying equipment such as spray tanks, tool or utility boxes, spray booms and the like, as well as being a vehicle for carrying loads of a wide range of types. ATV's are also widely used for towing another vehicle such as a trailer.

ATV's are commonly supplied with carriers (usually flatbed) both front and rear. However, the carrying capacity of such carriers may not be sufficient especially if carrier space is already occupied by equipment such as spray tanks, tool/utility boxes and the like.

Safety issues can also arise. In hilly and rugged terrain a heavy load, either on the ATV or on a trailer, can give rise to dangerous situations especially when going down hill in slippery conditions. Furthermore, an ATV carrying a heavy load on its rear carrier can become unbalanced or unstable when traversing upward slopes.

While the present invention relates to a foldable carrier that has particular application to vehicles and more particularly ATV's, the invention also has application in static situations such as racking, stacking and shelving in all manner of locations. Therefore, while the following description of the invention, according to one preferred embodiment, will describe the foldable carrier in its application with a vehicle, more particularly a farm ATV, this is by way of example only and the invention is not limited to such end use applications.

### SUMMARY OF THE INVENTION

An object of the invention is to provide a robust, foldable, easily assembled and disassembled carrier that can be mounted onto a vehicle as a fitting, accessory or as a structural part and to fixing points on structures such as walls for use as shelving, baskets and racking in warehousing, retailing, indoor/outdoor markets and other similar activities.

A particular attribute of the invention is its utility wherever space saving, compact format of shelving, carrying and displaying capability is required.

Broadly according to one aspect of the invention there is provided a foldable carrier including a mounting frame, a floor movably coupled to the mounting frame, side members movably coupled to the mounting frame and connecting means for connecting the side members to the floor for retaining the floor in an in-use position, the floor and side members being moveable to a compacted state and held therein by retention means.

In a preferred form of the invention the floor, when an in-use position, slopes upwardly from the mounting frame to a wall member. In the preferred embodiment the wall member is located, in the in-use position, spaced from but substantially parallel to the mounting frame.

Preferably the connecting means includes the wall member. The connecting means can include individual releasable connectors whereby each side member is releaseably coupled to a part of the wall member.

In a preferred form of the invention that releasable connector is a pin projecting from one of the side member or wall member and engageable through an opening in the wall member or side member as the case may be, there being clip means engageable with the distal end of the pin.

In a preferred form of the invention the clip is an “R” clip a leg of which is engagable through a bore in the distal end of the pin.

Preferably the floor is moveably coupled to the mounting frame by a hinge arrangement whereby the floor can be folded back onto the mounting frame to form the compacted state of the carrier

In the preferred form of the invention each side member is coupled to the mounting frame by hinges, the hinges being arranged such that the side member when moved to the compacted state overlie the floor after the floor has been folded back onto the mounting frame.

Preferably the wall member is pivotally coupled to the floor and capable of folding onto the floor.

Preferably the retention means includes a releasable clip engageable between the side member and the mounting frame.

### BRIEF DESCRIPTION OF THE DRAWINGS

In the following more detailed description of the invention according to one preferred embodiment reference will be made to the accompanying drawings in which:

FIG. 1 is a perspective view of the foldable carrier in its in use configuration when mounted to the front safety rail, frame or the lie of an ATV,

FIG. 2 is an elevation view looking toward the frame that is attachable to the ATV,

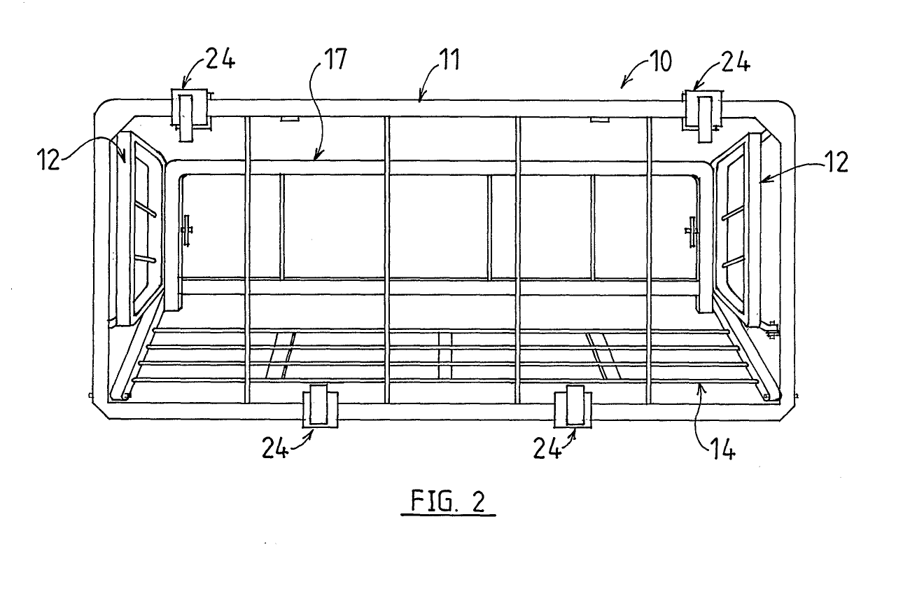

FIG. 3 is an elevation view in the direction opposite to FIG. 2,

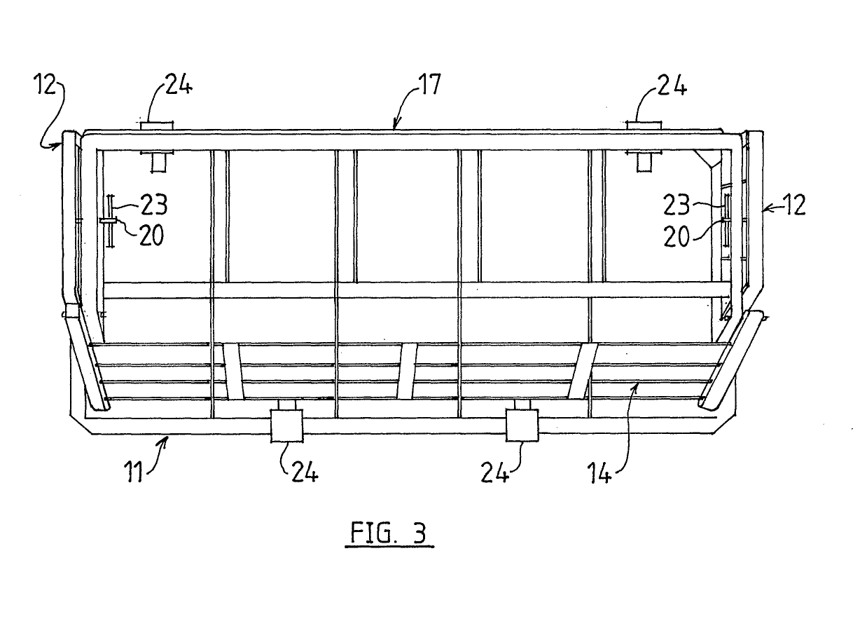

FIG. 4 is a view similar to FIG. 3 but showing the carrier in an unfolded configuration,

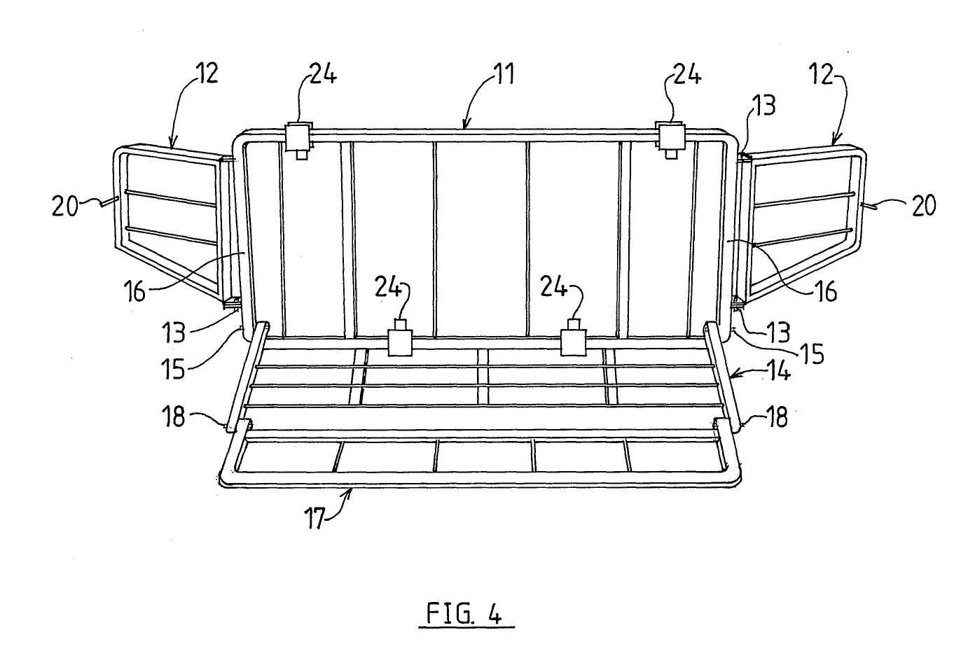

FIG. 5 is a side perspective view,

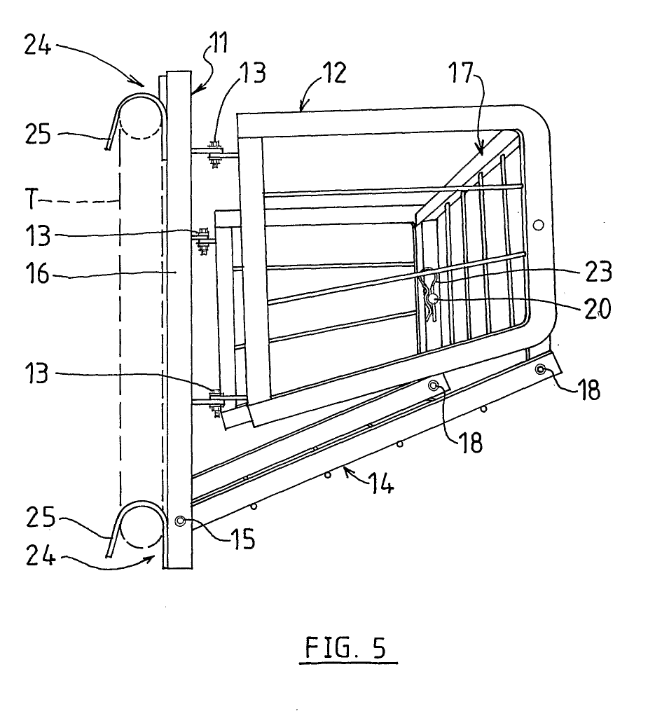

FIG. 6 is a side elevation view of the carrier in its folded configuration,

FIG. 7 is a front perspective view of the carrier in its folded configuration and

FIG. 8 is a view similar to FIG. 1 but showing the foldable carrier in a configuration to facilitate easier loading or unloading of a load.

### DESCRIPTION OF A PREFERRED EMBODIMENT OF THE INVENTION

The invention provides a foldable carrier for transportation by being mountable on a vehicle or in static applications such as a racking and stacking system.

The carrier can be constructed from any manmade materials eg steel, plastic or space age composite material, including wood and is a structure that when folded out and locked into place using e.g. two “R” clips becomes a carrier for all types of vehicles but especially ATV's, and as shelving, racking and stacking units when applied to: warehousing, expos, exhibitions, trade shows, retailing, indoor/outdoor markets and other similar activities.

The carrier can be disassembled quickly by pulling out the “R” clips, or the like, swinging back two side-wings of the unit that are attached on hinges past 90° to allow the front of the carrier to then fold onto the bottom of the unit which then folds up square with the back of the unit and is finally resecured when the two side-wings are refolded back 180° and locked back into place using the same two “R” clips for the now folded up carrier.

The carrier is designed so that it is compact, unobtrusive on space utilisation when closed, but provides useable volume of storage and carrying capacity when assembled. The only requirement to secure the unit when assembled and or disassembled is via the two “R” clips.

The carrier is mounted on vehicles, walls or railings by using adjustable sliding brackets (or screws when mounted on walls) that are attached to the top and bottom rails on the back of the carrier. This ensures a multitude of fit for different vehicles or positioning of the unit.

In the accompanying drawings the foldable carrier according to its preferred embodiment is shown attached to the front safety rails or bars R of an ATV. This is by way of example, as it will be appreciated by those skilled in the art that the foldable carrier can be mounted to any vehicle in an appropriate position e.g. it could be the front bull bars of a four wheel drive vehicle or utility, or some other frame or chassis part of the vehicle, or it could be a static structure such as a wall, framework or even a fence, or part of a farm race if the carrier is to be used simply for providing a platform for retaining a small animal such as a sheep so that veterinary or other animal healthcare work can be carried out on the animal.

The carrier 10 is made up of a number of elements including, a back or mounting frame 11 and side frames 12 that are hingedly mounted via hinges or pivots 13 to the back frame 1.

Pivotally mounted to a lower end of the back frame 11 is a bottom or floor frame 14. This bottom frame 14 is pivotally coupled by pivots 15 to an upright or side member 16 of the back frame 11. It is to this upright member 16 that hinges 13 of the side frames 12 are attached.

A wall or so-called front frame 17 is located opposite but spaced from the back frame 11. This front frame 17 is pivotally coupled by pivots 18 to the floor frame 14.

As is evident from the drawings, the bottom frame 14 when the carrier 10 is in the use configuration slopes upwardly away from the back frame 11. This is a preferred arrangement intended for ATV application as it ensures that the front ground clearance of the ATV is retained when the ATV is in a nose down attitude such as proceeding down a ramp toward a surface at an angle thereto or when negotiating the bottom of say a hill or incline.

Each of the hinged side frames 12 incorporates a locking arrangement whereby the distal end of the side frame 12 can be locked, latched or otherwise detachable connected to the front frame 17. In the preferred form of the invention the distal vertical member 19 of each of the side frames 12 is provided with a projecting pin 20. This engages through an opening 21 in the vertical member 22 of the front frame 17. The aforementioned “R” clip 23 has one leg thereof engaged through an opening toward the distal end of the pin 20 so as to retain the pin 20 in the opening 21.

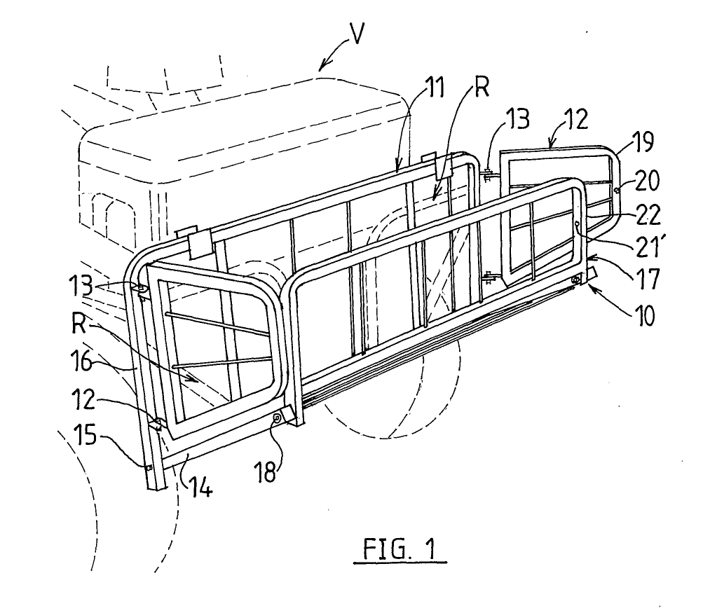

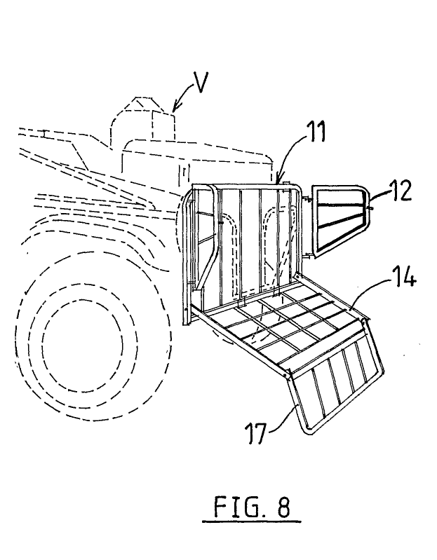

FIG. 1, shows one of the hinged side frames 12 in the position where it is retained with the front frame 17. The other side frame 12 is shown with the “R” clip 23 removed and, therefore, the side frame 12 hinged away from the front frame 17 and bottom frame 14. Accordingly, with both “R” clips 23 removed, the front frame 17 and the bottom frame 14 can be hinged downwardly into the position shown in FIG. 8.

As shown in FIG. 8 the bottom frame 14 is presented in a manner such that a load can be engaged thereon. Thus, if for example a small animal such as a sheep is to be transported, the sheep can be laid on its back on the bottom frame 14 and then, via force applied to the front frame 17, the whole arrangement can be lifted upwardly to couple the front frame 17 to the side frames 12. This thereby overcomes the need for a farm worker having to lift the sheep up over the front frame 17 when it is in the fully raised position i.e. the position shown in FIG. 1.

The carrier 10 is mounted to the vehicle via mounting brackets 24. These mounting brackets can be of any type suitable for the particular application. In the arrangement as shown, the mounting brackets 24 can be a pair of inverted U-shaped elements 25 which engage over a tubular element T of the safety rail, carrier or the like of the ATV. As can be seen there are a pair of mounting brackets top and bottom of frame 11.

Each of the upper U-shaped elements 25 is coupled to plate 26 which is located to one side of top member 27 of frame 11. A similar plate 28 is located to the other side of top member 27. Bolts are engaged through aligned openings in the plates 26 and 28. With nuts threaded onto the threaded ends of the bolts the whole arrangement can be tightened up so as to clamp the U-shaped element to the rear frame 11 at the required location point.

In the preferred form of the invention there are four mounting brackets, two at the top and two at the lower end of the back frame 11. The mounting brackets, by being movable in position on the back frame 11, provides the degree of adjustability necessary to enable the carrier to be fitted to the most popular ATV brands. Long bolts are inserted through aligned openings in the two upper U-shaped element mounting brackets 25 which go under the tubular element T of the top safety rail to ensure that the carrier is properly secured to the safety rail T and will not bounce off when traversing rough terrain.

According to the illustrated form of the invention, each frame is made of metal. Thus, each frame can include a peripheral frame with a plurality of bars spaced apart and substantially parallel, mounted between opposing parts of the peripheral frame. The peripheral frame can be hollow tube of angular cross-section. The bars can be of solid circular cross-section form.

With the carrier 10 in the configuration shown in FIG. 1, the carrier can be used for transportation of a wide variety of loads such as gear required by a farm worker, liquids in containers, farm equipment, animals, hay bales, fencing componentry to name but a few of the typical loads which would be carried in a farm application. As noted above the carrier can be used in a wide range of applications and, therefore, the type of loads that could be carried by the carrier will be apparent to the users of ATV's in the wide range of uses to which such vehicles are put.

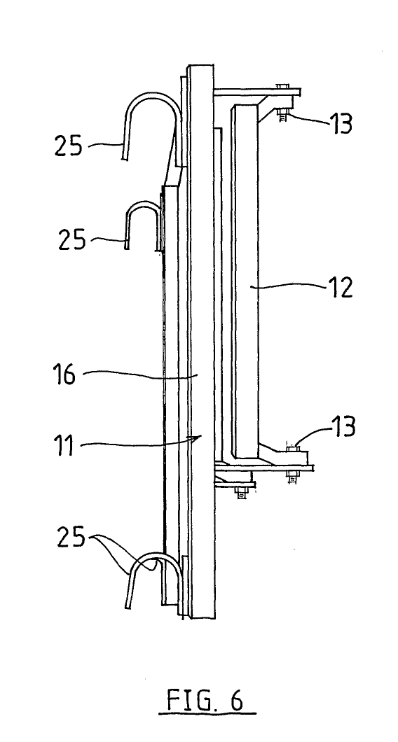

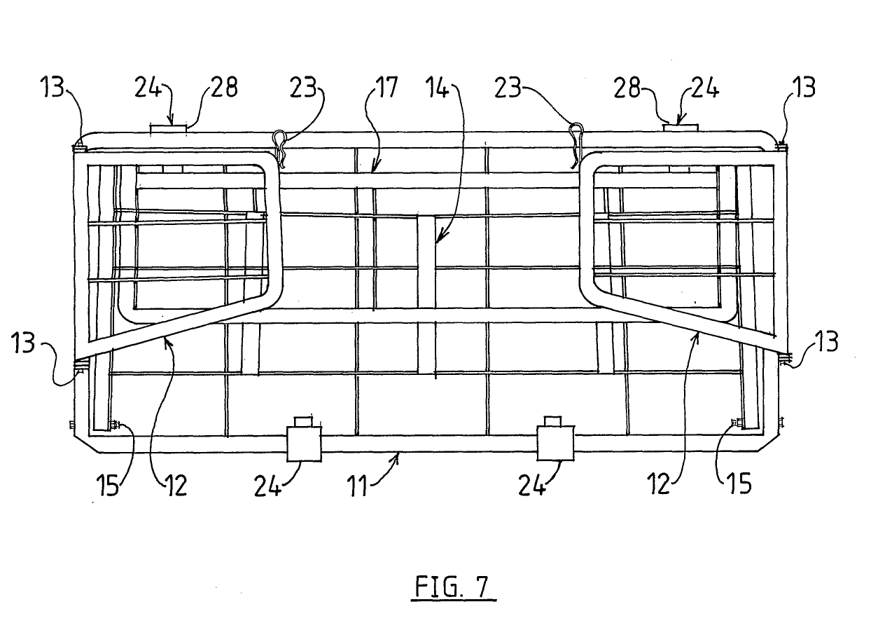

When the carrier is not required it can easily and quickly folded into a compacted form as shown in FIGS. 6 and 7. By removing the “R” clips 23 the front frame 17 can be folded back onto the upper surface of the bottom frame 14 and then the two frames hinged back as a unit up against the rear frame 11. The side frames 12 can then be hinged to the position over the bottom frame 14. By use of the “R” clips 23 engaged through suitable lugs positioned on the back frame and engagable with pins 20 the whole construction is held in the folded/compacted configuration.

With the carrier folded back into itself it only protrudes, in its preferred form, about 90 mm from the front of the safety rail of the ATV. Therefore, the additional protrusion on the front of the ATV is minimal. This permits the ATV to still be loaded onto its towing trailer or fit into a tight garaging or storage space without the need to fully dismantle the carrier. The folded carrier also provides increased frontal protection for the ATV.

The foldable carrier according to the present invention is, therefore, easily mountable to a vehicle so as to increase the load carrying capacity of the vehicle. It can equally be easily and readily reconfigured from stowed to in-use positions. Additionally, in the preferred form of the invention, part of the carrier can be lowered for facilitating the loading and unloading of the carrier. The carrier, therefore, provides a versatile piece of equipment for vehicles, particularly ATV's but equally can, as stated above, have applications in fixed locations as described above.

1-16. (canceled)

17. A foldable carrier including a mounting frame, a floor movably coupled to the mounting frame, side members movably coupled to the mounting frame and connectors for connecting the side members to the floor for retaining the floor in an in-use position, the floor and side members being moveable to a compacted state and held therein by a retention device.

18. A foldable carrier as claimed in claim 17 wherein in an in-use position the floor slopes upwardly from the mounting frame to a wall member.

19. A foldable carrier as claimed in claim 19 wherein the wall member is located, in the in-use position, spaced from but substantially parallel to the mounting frame.

20. A foldable carrier as claimed in claim 18 wherein the connectors includes said wall member.

21. A foldable carrier as claimed in claim 20 wherein the connectors includes individual releasable connectors whereby each side member is releaseably coupled to a part of the wall member.

22. A foldable carrier as claimed in claim 21 wherein the releasable connector is a pin projecting from one of the side member or wall member and engageable through an opening in the wall member or side member as the case may be, there being a clip device engageable with the distal end of the pin.

23. A foldable carrier as claimed in claim 22 wherein the invention the clip device is an “R” clip a leg of which is engagable through a bore in the distal end of the pin.

24. A foldable carrier as claimed in claim 23 wherein the floor is moveably coupled to the mounting frame by a hinge arrangement whereby the floor can be folded back onto the mounting frame to form the compacted state of the carrier

25. A foldable carrier as claimed in claim 24 wherein each side member is coupled to the mounting frame by hinges, the hinges being arranged such that the side member when moved to the compacted state overlie the floor after the floor has been folded back onto the mounting frame.

26. A foldable carrier as claimed in claim 25 wherein the wall member is pivotally coupled to the floor and capable of folding onto the floor.

27. A foldable carrier as claimed in claim 26 wherein the mounting frame includes a peripheral frame with a plurality of bars extending between a pair of opposing sides of the peripheral frame.

28. A foldable carrier as claimed in claim 27 wherein the plurality of adjustable clamps are coupled to the peripheral frame for mounting of the mounting frame for mounting of the mounting frame to a fixture.

29. A foldable carrier as claimed in claim 28 wherein each of the side members and the floor each includes a peripheral frame mounting a series of spaced apart substantially parallel bars.

30. A foldable carrier as claimed in claim 29 wherein the wall member includes a peripheral frame having a plurality of spaced apart substantially parallel bars extending between a pair of opposed parts of the peripheral frame of the wall member.

31. A foldable carrier as claimed in claim 30 wherein the retention device includes a releasable clip engageable between the side member and the mounting frame.

32. A foldable carrier as claimed in claim 19 wherein the connectors includes said wall member.

33. A foldable carrier as claimed in claim 32 wherein the connectors includes individual releasable connectors whereby each side member is releaseably coupled to a part of the wall member.
